(19) United States
(12) Patent Application Publication
(10) Pub. No.: US 2018/0232538 A1
(43) Pub. Date: Aug. 16, 2018

(54) SYSTEMS AND METHODS FOR AUTOMATIC GENERATION, MANAGEMENT AND USE OF MULTIPLE ARTIFICIAL IDENTITIES

(71) Applicant: PCMS HOLDINGS, INC., Wilmington, DE (US)

(72) Inventor: Mung CHIANG, Carmel, IN (US)

(73) Assignee: PCMS Holdings, Inc., Wilmington, DE (US)

(21) Appl. No.: 15/748,899

(22) PCT Filed: Aug. 3, 2016
(86) PCT No.: PCT/US2016/045257

§ 371 Date: Jan. 30, 2018

Related U.S. Application Data
(60) Provisional application No. 62/200,352, filed on Aug. 3, 2015.

(51) Int. Cl. G06F 21/62; H04L 29/06; H04L 29/08

(52) U.S. Cl. CPC G06F 21/6263; H04L 67/22; H04L 63/0421; G06F 21/6254

(57) ABSTRACT

Systems, methods, and instrumentalities are described for processing personal information implemented in an entity on a wireless transmit/receive unit (WTRU), the method comprising receiving, from a user, an indication associated with a first browsing session, wherein the first browsing session is associated with a website/app, creating, by the entity, a first artificial digital identity associated with the first browsing session, storing first browsing information associated with the first browsing session, wherein the first browsing information is associated with the user, receiving, from the user, an indication associated with a second browsing session, wherein the second browsing session is associated with the website/app, creating, by the entity, a second artificial digital identity associated with the second browsing session, storing second browsing information associated with the second browsing session, wherein the second browsing information is associated with the user, receiving a request for a browsing history and sending the request to the user, wherein the request is associated with the website/app, on a condition that the user accepts the request, sending the browsing history in response to the request, wherein the browsing history combines the first browsing information and the second browsing information.

### CROSS REFERENCE TO RELATED APPLICATION

This application claims priority to U.S. provisional patent application No. 62/200,352, filed Aug. 3, 2015, which is hereby incorporated by reference herein.

### BACKGROUND

Consumers (e.g., users) generally interact with two types of websites or mobile apps that ask for identifying information. Certain websites/mobile apps/services require a true user identity to function properly (e.g., websites/mobile apps/services, such as, for example, online banking or FACEBOOK®). Typically, these are referred to as Type I websites/apps/services. Some or most of Type I websites may ask to validate user (e.g., confirming she may be the actual person she claims to be) each time she logs in.

In contrast, some websites/apps do not need a true user identity to function properly, but ask for users to log in nonetheless. Typically, these are referred to as Type II websites/apps/services. Type II websites do not use true digital identity verification during log-in, and do not check the one-to-one correspondence between a username and the underlying real human being identity.

Currently, with Type II websites, there may be a privacy concern, as user activities may be tracked and may be sold to big data companies such as advertisers (or worse entities). For example, a user may be fleeced for personal information and browsing history as they interact with service elements on the web even though their actual identity is not necessary to receive the same level of experience. Solutions to provide such information may, unfortunately, be dictated by each website and, thus, may not be consistent across sites that a user may visit nor provide real control to the user.

A user may achieve a level of anonymity by logging in through different digital identities. Unfortunately, this must be manually performed, and may require the user herself to keep track of the various digital identities. For example, existing solutions may be about (a) managing multiple real physical identities, or (b) true digital identities according to different profiles, or (c) manually managing artificial identities. In particular, existing solutions may be about managing multiple identities for multiple purposes (e.g., one identity for education portal and another for social networks), and a username and password management service may be used in such solutions.

### SUMMARY

Systems, methods, and instrumentalities are disclosed for processing personal information implemented in an entity on a computing and communication device, such as a wireless transmit/receive unit (WTRU) or a connected server. The entity may receive, from a user, an indication associated with a first browsing session, wherein the first browsing session is associated with a website/app. The entity may create a first artificial digital identity associated with the first browsing session. The entity may store first browsing information associated with the first browsing session, wherein the first browsing information is associated with the user. The entity may receive, from the user, an indication associated with a second browsing session, wherein the second browsing session is associated with the website/app. The entity may create a second artificial digital identity associated with the second browsing session. The entity may store second browsing information associated with the second browsing session, wherein the second browsing information is associated with the user. The entity may receive a request for a browsing history and send the request to the user, wherein the request is associated with the website/app. On a condition that the user accepts the request, the entity may send the browsing history in response to the request, wherein the browsing history combines the first browsing information and the second browsing information.

### BRIEF DESCRIPTION OF THE DRAWINGS

FIG. 1 is a diagram of an example system for managing personally identifying information.

FIG. 2 is a flow diagram of an example method (e.g., an automated method) for interfering with the passive collection of personally identifying information and/or for generating, managing, and/or using artificial digital identities.

FIG. 3 is a diagram of an example system using more than one layer of identification (ID) protection.

FIG. 4 is a diagram of an example method that may be used to monetize mapping of artificial identities.

FIG. 5 is a diagram of an example system for managing personally identifying information.

FIG. 6 is a diagram of an example method that maybe used to generate and/or provide artificial identities associated with a user.

FIG. 7 is a diagram of a wireless transmit/receive unit (WTRU).

FIG. 8 is a diagram of a WTRU having a variety of computing applications.

FIG. 9A is a diagram of an example communications system.

FIG. 9B is a diagram of an example radio access network and an example core network that may be used within the communications system illustrated in FIG. 9A.

FIG. 9C is a diagram of another example radio access network and an example core network that may be used within the communications system illustrated in FIG. 9A.

FIG. 9D is a diagram of another example radio access network and an example core network that may be used within the communications system illustrated in FIG. 9A.

### DETAILED DESCRIPTION

A detailed description of illustrative embodiments may now be described with reference to the various Figures. Although this description provides a detailed example of possible implementations, it should be noted that the details are intended to be exemplary and in no way limit the scope of the examples described herein.

Examples herein (e.g., systems and/or methods) may enable or allow an automatic breakdown of “big data” into “small data,” protecting users and providing them with choice and control of their own data. Systems and/or methods provided may artificially and automatically create and manage multiple digital identities for a given website/digital service (for example, where data collected about an individual may not be desired or trusted by a user). The management of such multiple identities may be processed (e.g., automatically) on the user client devices, and may be provided and/or revealed to the website when scope of data collection and sharing of monetization may be agreed explicitly by the user. Throughout this specification, for brevity, “website” may be used as an abbreviation for websites, apps, and/or services that seek to collect data about the user. Use of website as opposed to slashes (such as website/app or websites/apps/services) is not intended to be limiting.

Systems and/or methods provided may create, manage, and/or monetize one or more artificial identities for the same user and/or person automatically (e.g., without user interaction). Systems and/or methods may avoid tracking big data (e.g., when such tracking may not be available or desired), may divide or break big data into chunks of “small data” with control and transparency at a client side, and/or may provide a user with the flexibility of signing in with different identities without the user having to be involved with the method or process.

Systems and/or methods provided may interfere with the passive collection of personally identifying information. For example, individual identification credentials may be created and/or managed for each website, or application server (or each interaction). Such credentials may include electronic identification information (e.g., existing and/or newly created) or identification (ID)s that may be unique to the website may be provided and/or generated for a specific website or application server. Further, such credentials may include cookies and/or bread crumbs for the sites. The cookies and/or bread crumbs may be associated with the ID and may be signaled to the application and browsers to support compartmentalization thereof. These credentials and identifies thereof may be managed and/or stored in a database such as a user proprietary database. The user via the application or browser may be able to interact with the website or application server and such information or credentials or identifies may be sent and/or provided without user interaction.

A user may be able (e.g., may be free) to interact with services in a manner that may enable them to share the information they choose either in a relationship, or single transaction manner. A user may receive offers by websites, or application servers and/or may determine or consider whether to reveal other user credentials used with them, or other sites as well (e.g., offers may be received from e-commerce sites such as AMAZON® and/or advertising agencies that may contact the system to provide monetary reward for revealing user credentials to them). Further, a user may monetize the compartmentalization they've created, but choose to reveal to specific vendors the ID's the user may have used. For example (e.g., in such a compartmentalization), the user may avoid having a single outside entity from getting too much data about the user's preference, behavior, taste, and/or the like and may be able to monetize off of the opportunity the user may provide to those parties interested in obtaining such data.

Systems and/or methods provided may obfuscate and/or hide a true identity of a user to one or more websites/apps. One way to “confuse” the websites and to obfuscate the true identity may be to artificially create multiple digital identities for the same website or mobile app. Systems and/or methods herein may automatically enable the creation, management, and use of multiple artificial identities as transparently to users as possible.

Further, in comparison with services that may manage multiple digital identity profiles for multiple and different online services, one profile per service, the examples (e.g., the system and/or methods) herein may provide multiple profiles for the same single online service. These multiple profiles may be managed through automation with minimal end-user human involvement. This difference may be visualized as follows. Currently, there may be N profiles for N different services (N:N, or 1:1 per service) and examples herein may provide N profiles for one service or single online service (N:1, or >1:1 per service). Further, the examples herein may enable personal “big data” to be broken down to “smaller data,” which may lead to one or more advantages including one or more of the following. For example, the examples herein may enable the separation of the function of website features from the function of identity revealing. By decoupling these two functions, a user may use certain websites without having to reveal her true identity. Further, the examples herein may enable breaking big data into smaller data and/or controlling the mapping of digital entities. By breaking big data into small data, each user may have a higher assurance of not getting her data improperly used. By controlling the mapping from artificial digital identities to the single true identity of herself, the user also may have a chance to benefit from monetization of big data.

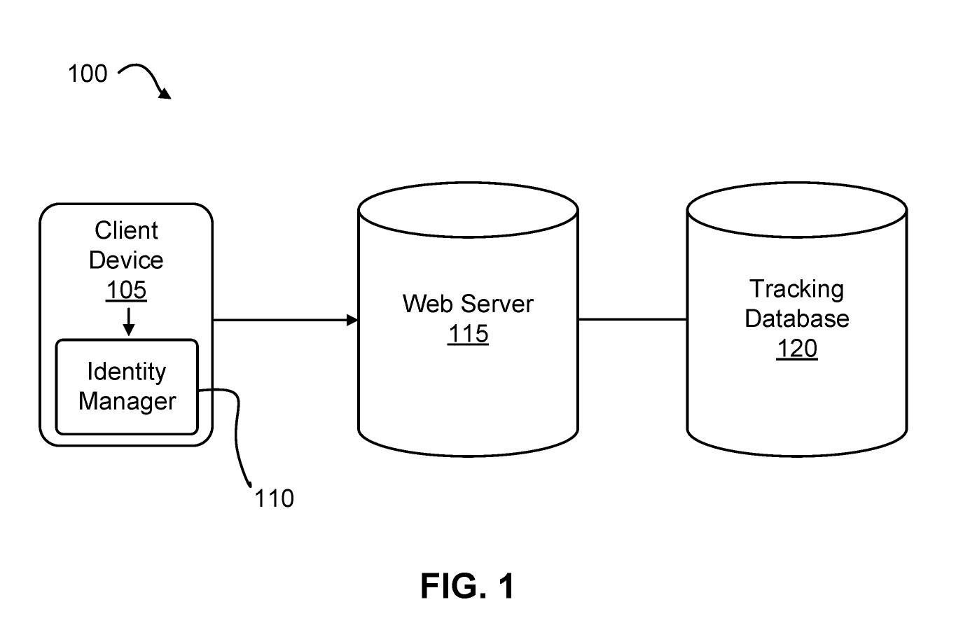

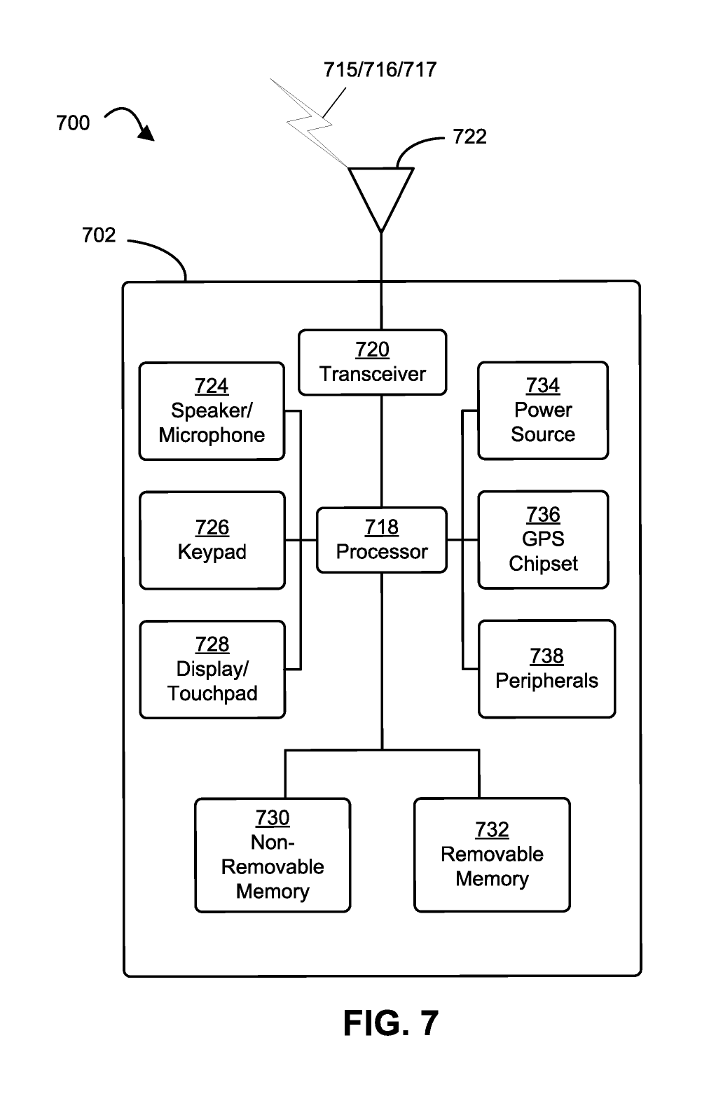

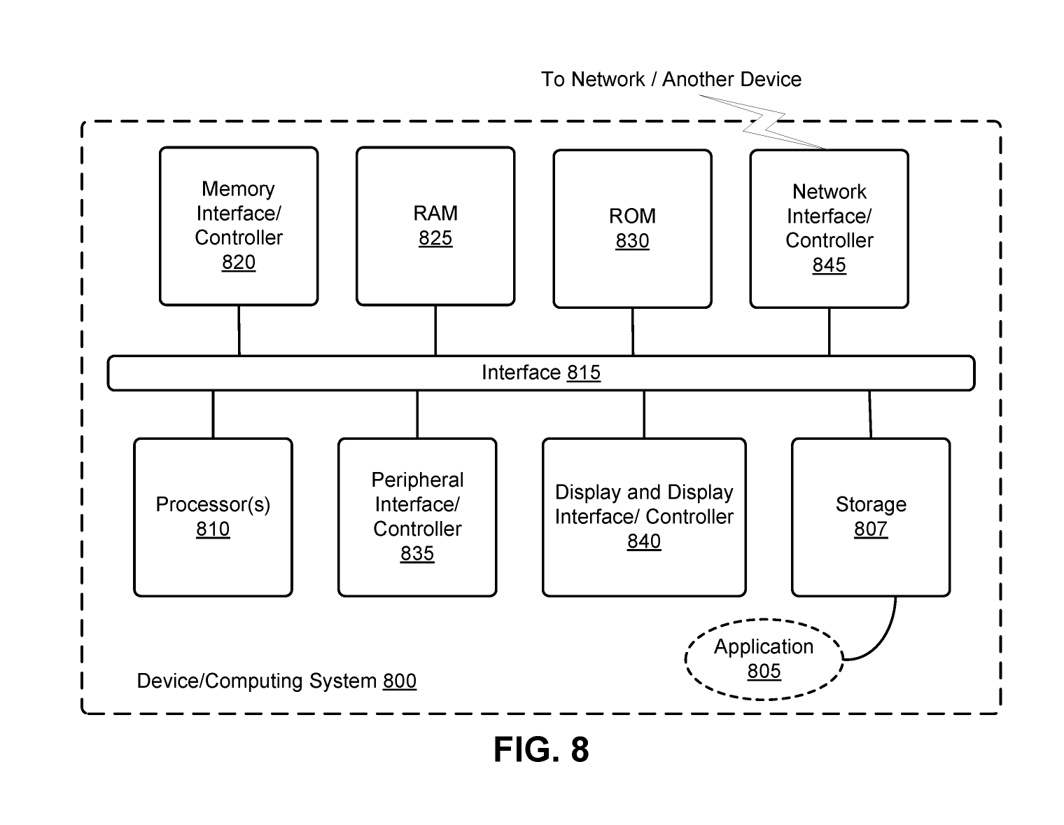

FIG. 1 illustrates an example system 100 that may implement one or more of the examples herein. As shown, the system 100 may include a client device 105. The client device 105 may be a mobile device, computer, and/or the like such as those described in FIGS. 7-8.

An identity manager component 110 may be included in or may reside on the client device 105 as shim layer. The identity manager component 110 may provide and/or perform an automated method or process for generating, managing, and/or using artificial digital identities.

The system 100 may include a web server 115 and/or a tracking database 120. The client device 105 may communicate (e.g., via a network connection such as the Internet and/or a communication system as described herein) with the website server 115. The website server 115 may include website functions (e.g., functions such as website login, content hosting, advertisements, and/or the like) and/or may provide the same to the client device 105.

The tracking database 120 may be a data tracking storage server that may be in communication with the web server 115 (e.g., via a direct connection or link and/or wirelessly via the Internet or another network connection as described herein). The tracking database 120 may store the user data, including performance data, behavior data, and/or the like. In an example, the tracking database 120 may be typically owned by the website (e.g., that may also own the website server 115) and may be queried for information to be sold to third parties, such as advertisers, service providers, and/or the like. The examples herein may shift some of the control and transparency from this data tracking storage server to the client devices.

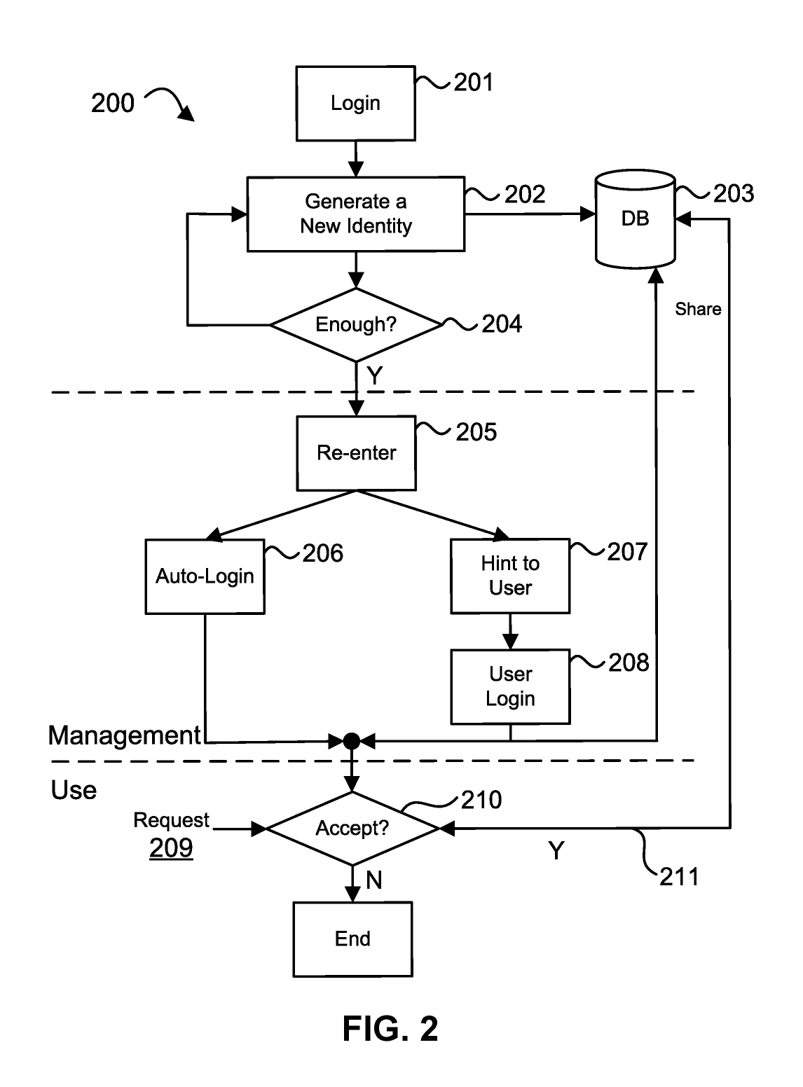

FIG. 2 illustrates a flow diagram of an example method 200 (e.g., an automated method that may be performed by the identity manager component 110) for interfering with the passive collection of personally identifying information and/or for generating, managing, and/or using artificial digital identities according to one or more examples herein. As shown, the method may include one or more phases including a “generation phase” (e.g., 201-204), a “management phase” (e.g., 205-208), and/or a “use phase” (e.g., 209-211). In examples, the generation phase may be a one-time phase whereas the management phase and/or the use phase may be recurring.

As shown, at 201, a login to a website may be initiated by a user of a device such as a client device (e.g., 105). For example, a user may interact with her client device to log into a website he or she may wish to access or visit.

At 202-204 (e.g., which may be looped), multiple digital identities (e.g., credentials and/or artificial identities) maybe automatically generated. For example, at 202, an identity (e.g., an artificial identity) may be generated, i.e., a new username, a password, and basic information such as email contacts. The email contacts may be the same, but the username and the associated password may be different, through random generations, across the artificial identities. A determination may then be made, at 204, of whether enough identities (e.g., more than a threshold) may be generated. In examples, enough identities (e.g., the threshold) may be generated and/or provided when more than one identity may be generated and/or provided, in one example, and/or 2-10 identities, according to an example, 5-10 identities, in examples, and/or the like.

If enough identities may have been generated (e.g., more than the threshold), the generation at 202 stops and the management phase may begin (e.g., at 205), otherwise the generation at 202 may keep going such that additional identities may be generated at 202. As shown, at 203, each of these identities may be stored in a database or storage component residing on the client device where there may be a mapping of artificial identities with a given true identity. If these may be stored in the cloud, they may be stored in a secure component that may not belong to the company owning the website.

In an example, at 205, another log in to the website may be initiated by the user. For example (e.g., after the “generation phase” and/or when enough identities may be generated and stored), the user may log into the website again at 205 such that the user may log into the website on a reoccurring basis. At 206 and/or 207-208, one or more modes of logging into the website may be provided and/or selected upon determining that the log in may be a subsequent log in at 205. As shown, in an example, there may be two modes of logging in to the website recurringly. In the “automatic login” mode, at 206, the user may enter her real identity through a user interface provided by this client-side application after entering the target website URL. Then, the client side application may open the browser and automatically log in using a randomly selected artificial identity associated with true identity, as stored in a database located either in a remote server or on the client device.

Alternatively or additionally, in the “manual login” mode, at 207-208, the user may enter the username and password of one of the randomly chosen artificial identities herself, with the help from the information provided by the client side software. For example, when the mouse, finger, or other input hovers above the username field, the client side software may detect this and act, so that the username of an artificial identity may be automatically put on the “copy and paste” board, or revealed to the user in a pop-up window at 207 (e.g., hinted to the user) and the user may log in with the artificial identity at 208.

Using either log-in mode, first credentials or a first artificial identity associated with a user for a first session (e.g. logging onto the website or service) with a service or website may be used. During that first session, according to examples herein, information or first cookies from the first session in local storage of a device associated with the user and/or a remote storage in communication with the device. In examples herein, in subsequent sessions (e.g., a second session), other credentials or artificial identities (e.g., different from the first credential or artificial identity) may be used. For example, second credentials or a second artificial identity for a second session with the service or website may be used (e.g., to log on). During that second session, information or second cookies from the second session in the local storage of a device associated with the user and/or the remote storage in communication with the device as described herein. In examples herein, the information or the first cookies from the first session may not be provided to the website during the second session and/or vice versa.

In the “data usage” phase (e.g., which may be reoccurring), the website/app or third party vendor may send a request to the client side application to obtain mapping between artificial and true identities, so that it can go from “small data” to “big data.” For example, at 209, a request may be received from website at the client device. At 210, a determination may be made on whether to accept the request or not. For example, at 210, the user may determine or decide whether to accept the request or not. To make such a determination, the user via the client device may go through a back and forth protocol to validate the identity and nature of the requesting party, thereby turning the table around in the process of user data collection. The user and/or client device may also negotiate the revenue sharing with the requester, based on any revenue that may be generated by selling her own data to others, which may provide a share of the monetary award associated with one's own data back to himself or herself. The user and/or client device may also request or demand that certain organizations on a whitelist be allowed to see the big data about him or her.

At 211 (e.g., if, after the above declaration and negotiation, the decision may be to accept the request,) the database storing the mapping of artificial identities into a given true identity may be shared with the requester (e.g., the website). Because the requester may already be tracking the data associated with each artificial identity, this mapping from the database may be (e.g., all that may be) needed for the requester to complete the big data acquisition.

As such (e.g., at 209-211), a request for information about multiple identities used for the sessions (e.g., the first and/or second sessions) with the service or website may be received. According to one or more examples, the request for information about multiple credentials or artificial identities used at the service or website further comprises information related to an offer of compensation for providing the information or the cookies.

As described herein, information regarding at least one of following: the first credentials or the first artificial identity from the first session and/or the second credentials from the second session or the information or the first cookies from the first session and/or the information or the second cookies from the second session in response to the request may be sent, for example, to the requestor. Further, the information may be sent responsive to a determination that the user accepts the offer of compensation for providing the information about multiple credentials or identities used at the service or website. The determination that the user may accept the offer of compensation further comprises receiving input from the user in response to displaying information related to the offer of compensation and/or comparing the offered compensation with a predetermined threshold, wherein the predetermined threshold was set based on user input.

The method (e.g., 200) may not have to be on websites and web-app-like interfaces. Rather, it may be used for mobile applicants or other types of human-computer interfaces, with a similar approach of creating and managing, automatically, a set of multiple artificial digital identities for a given user.

Further, as described herein, cookies may be managed in the systems and/or methods herein. For example, there may be different kinds of cookies. For examples herein, login cookies may be disabled in the browser. However, session cookies and persistent cookies may continue to be used, as they are associated with each logical user's activity. The cookies and/or information along with the artificial identities may be provided to a requestor upon approval by the user and/or acceptance of an offer to have such information as described herein.

Additionally, in examples, the “association with each logical user's activity” may be provided as follows either by default a browser may do this, or a local partition on the machine may be created to keep web sites from accessing cookies created by other sessions or logical users.

In examples, the identities (e.g., the artificial identities) that may be used and/or generated may be selected as follows. For example, the website to be accessed may be accessed by the client device (e.g., the identity manager component, and the website may be opened or launched). Such an examination may lead and/or result in a set of created identities as described herein that may have been generated for the user. One of those identities may be selected randomly or chosen randomly (e.g., by the client device and/or the identity manager component therein).

According to an example, the IP address of the client device may be hidden. For example, some websites determine the IP address of a machine. However, such a determination may not enable them to determine whether identity of the user logging in from this machine may be from or associated with the same person (e.g., especially as multiple people share access to the same machine). Still, IP address obfuscation may be provided in addition (e.g., to further improve privacy of a user). In such an example, Tor networks that anonymizes at machine level through its entry, relay and exit proxies, can may be used in conjunction with the examples herein. As such, logical identity obfuscation and machine identity obfuscation may be used to complement each other.

An aspect to realize for the examples herein may be that, with the proliferation of multiple devices shared across multiple members of a family (e.g., one iPad shared by many) and even one website shared by multiple people (e.g., one Netflix service shared by parents and children of a family), multiple logical identities may share the same device or service anyway. The examples herein may create artificial identities for each of those members automatically and systematically to obfuscate the real identities thereof.

For example, in examples, cookie management functions may be embedded in browsers such as Firefox CookieSwap, Chrom Swap My Cookies, Multifox and Safari Private Browsing. These functions may enable or make it convenient for users to switch across multiple logins and demonstrate the possibility of managing digital identities online. However, the key difference with the examples herein (e.g., from such function) may include the following: those functions may not use a deliberate creation of artificial identities, which use the systems and/or methods herein to complement such functions, and do so on a user-opt-in level with automated creation, management and use of artificial identities. Furthermore, as such, leveraging this deliberate breaking up of big data, by putting some control of data monetization in hands of the users, may not be provided by such functions and may be provided by the examples herein.

Similarly, as described herein (e.g., above), Tor and other machine identity (e.g., IP address) obfuscation may be used with examples herein (e.g., a machine's or device's IP may be obfuscated with systems like Tor while a user's ID may be obfuscated by the examples described herein such as the artificial identities created). For example (e.g., for “full protection and flexibility”), the systems and/or methods herein (e.g., as shown in FIGS. 1 and 2) may include the following IP address hiding, artificial identity management (e.g., as described in the examples herein), and/or automatic management of identities in browsers.

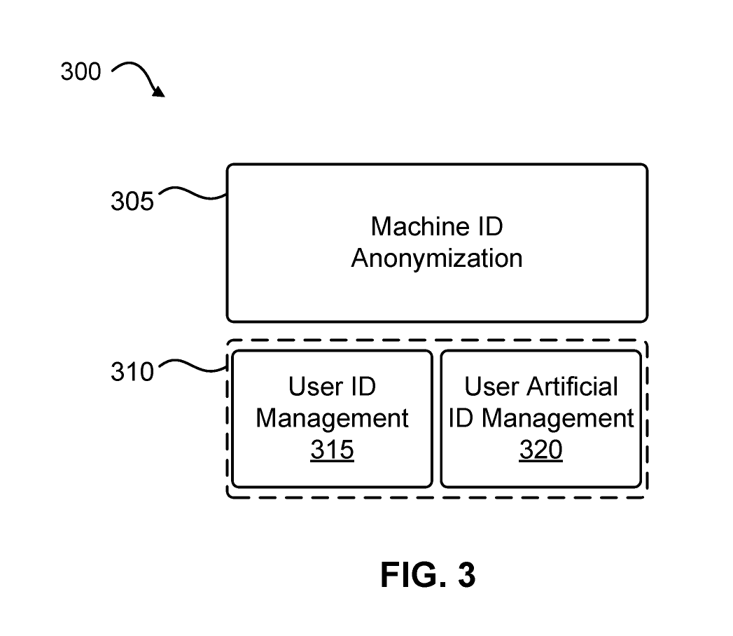

FIG. 3 illustrates a system 300 where two layers of ID protection may be used and/or provided. The system 300 includes a machine ID anonymization layer 305 and a ID management layer 310. The ID management layer 310 may include a user ID management component 315 and/or a user artificial ID management component 320. The layers (e.g., 305 and 310) may be complementary to each other such that (e.g., within the ID management layer) the artificial ID management component 320 may use and complement the ID management component 315.

A user may monetize these artificial identities and/or information associated with herself. For example, when asked or requested by the website, the user may decide whether to provide the mapping of the multiple artificial identities or not. The ability to provide or not provide such a mapping may help ensure policy transparency and may enable a potential monetary reward in exchange for providing data rights to the website owner.

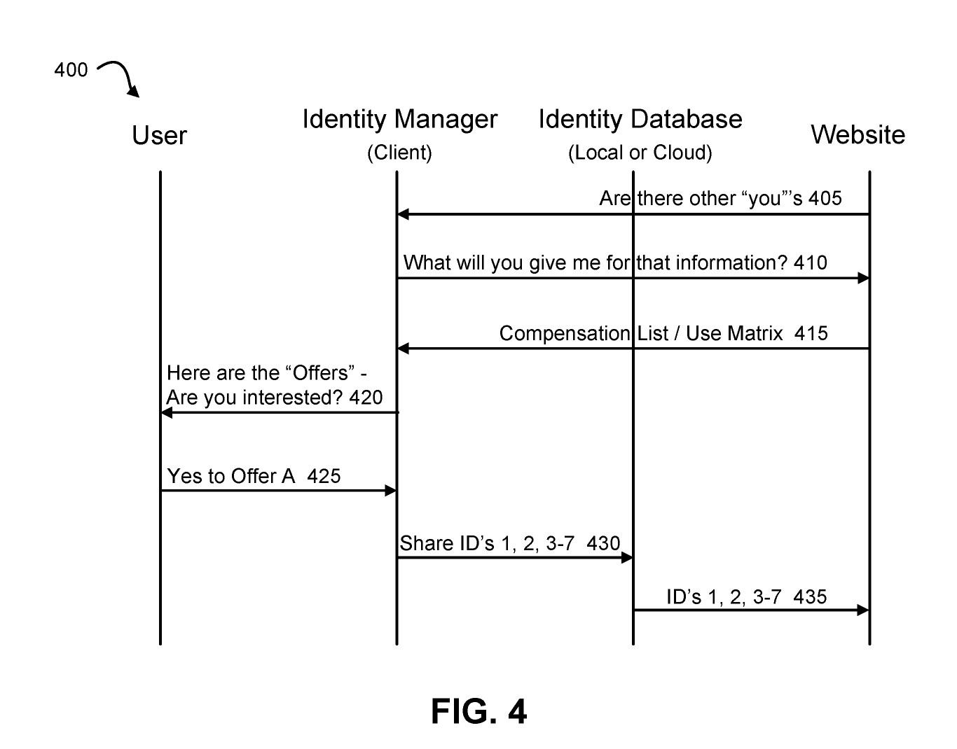

FIG. 4 illustrates a flow diagram of an example method 400 that may be used to monetize the mapping of artificial identities. As shown, at 405, a request may be sent by a website and received an identity manager component (e.g., 110) on a client device (e.g., 105) that may be operated by the user. The request may include an indication or information asking whether there may be other identities associated with the user. The identity manager component may respond to the request with a message that may be sent, for example, to the website and received thereby at 410. The message may include an indication or information asking the website what compensation or other information may be given for providing the mapping and/or identities.

The website may send a list or matrix (e.g., a compensation list and/or use matrix) that may indicate the compensation or offers it may provide for the mappings and/or identities that may be received by the identity manager component at 415. The identity manager component may display and/or provide the compensation or offers to the user at 420 (e.g., may display it on the client device). The user may then interact with the client device to select one or more of the offers or none of the offers. For example, the user may use a mouse, finger, and/or other input components to select one or more of the offers and/or none of the offers at 425 (depicted as “yes” for clarity of illustration). The selection may be sent and/or received by the identity manager component at 425. If accepted, at 430, the identity manager component may then send an indication of the identities and/or mappings the user may have selected to share via the compensation and/or offer (e.g., at 425) to the identity database (e.g., 120). The identities or mappings may then be sent (e.g., shared) to the website and received thereby at 435.

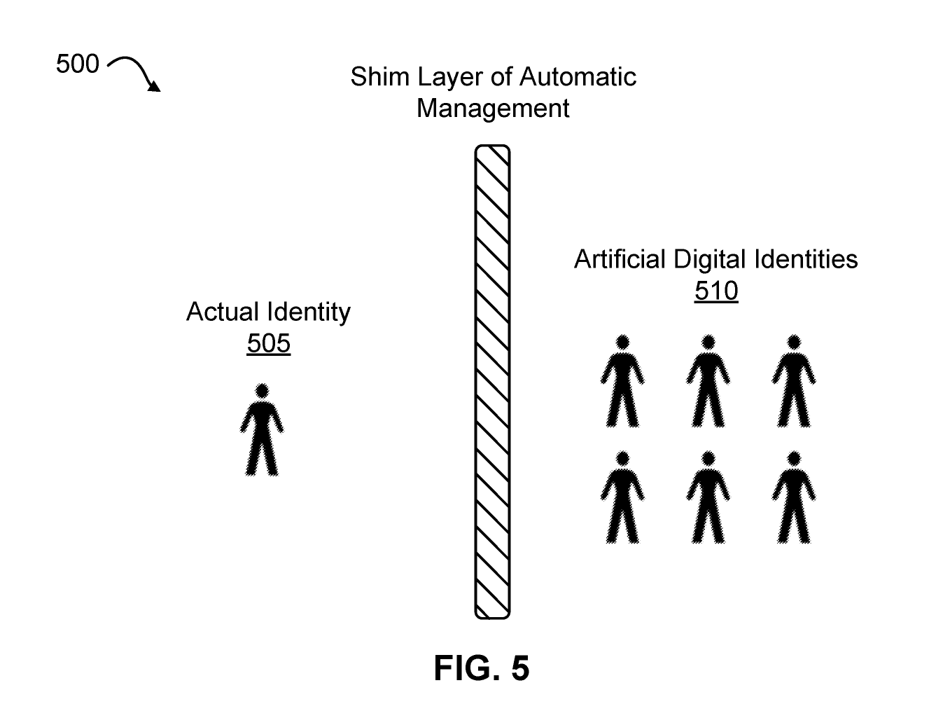

FIG. 5 illustrates an example system 500 for managing personally identifying information. As shown, an actual identity of a user (e.g., 505) may be mapped to one or more artificial identities (e.g., 510) via a shim layer of automatic management. The shim layer of automatic management may be provided by, e.g., the identity management component 110 and/or the user artificial ID management component 320). The system 500 may be implemented in a portal, such as an open online education portal including Coursera, Udacity, or EdX. In such an example, a given user may typically take several courses over a span of several years. Her activities, from performance to time of login, may be stored over that span. The online education website may keep track of behavior data and may sell it to other companies for financial returns, a primary mode of their monetization path in their current business model.

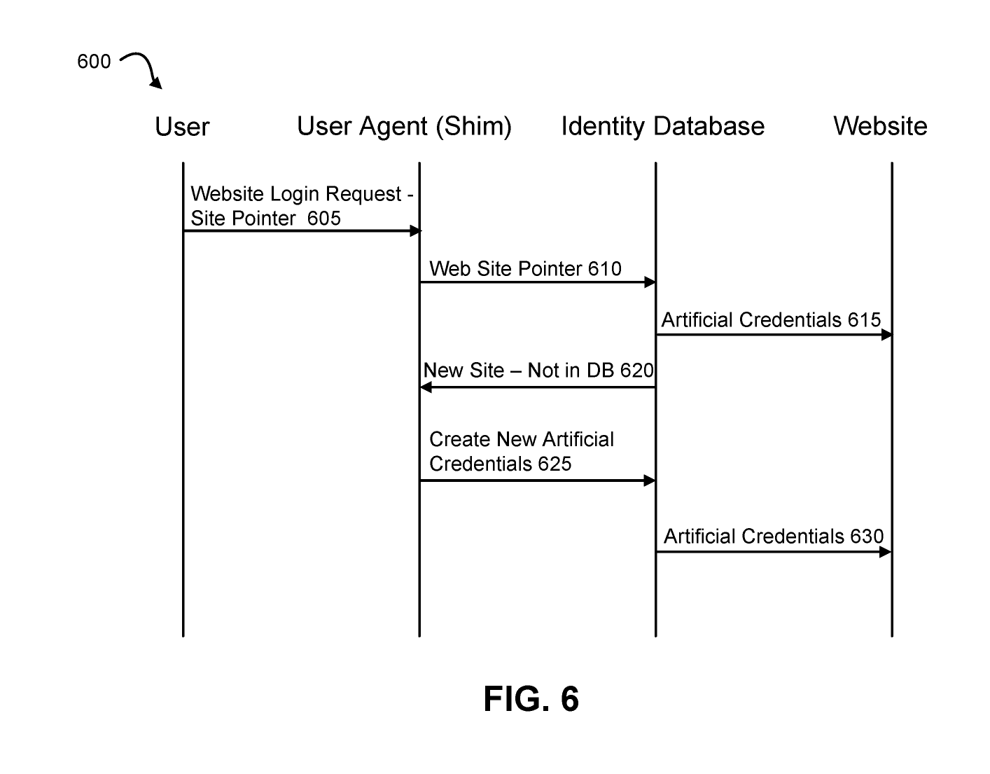

The users on these portals may (1) not have full knowledge of how their study behavior or performance data is used, or (2) not share in the resulting financial returns. The examples herein may help to solve both of those. The method or process may be performed and/or may run as follows (e.g., which may be shown in FIG. 6).

As described herein, an identity (e.g., artificial identity) may be generated and/or randomly selected to be used for logging into the portal. A user may log into a different course using a different artificial identity, thereby turning “big data” into “small data” and protecting her long-term massive data privacy and also incentivizing the website to pay him or her for data sales proceeds. Further, in such an example, data consistency may be maintained locally on the client device. For example, if the user may want to keep track of her education progress, the user may do so on her local client device.

Additionally, in examples, the mappings to one or more of artificial identities associated with the user may be provided to the websites at the discretion of the user (e.g., rather than by the online education website doing so without the user's knowledge). For example, if the terms of privacy protection and revenue sharing from the online education website may be agreeable to a user, the user may request and/or ask the client side application (e.g., the user agent or shim or identity management component such as 110 and/or 320) to release the mapping between artificial and true identities to the website.

According to additional examples herein, the database of multiple artificial digital identities may be synced-up across each of client devices belonging to the same user following the same user interface design, e.g., multiple smart phones, tablets, laptops and desktops, such that that when the user logs in from each of these devices, the same service of identity management may be triggered.

FIG. 6 illustrates a flow diagram of an example method 600 that may be used to generate and/or provide a mapping of artificial identities associated with a user that may be provided to the portal. As shown, at 605, a user may log into a website and a request (e.g., a site pointer to the website) may be sent and received by a user agent or the shim layer (e.g., that may be similar or the same as an identity manager component (e.g., 110) on a client device (e.g., 105)). The user agent or the shim layer may send a pointer to the website the user may want to log into to the identity database (e.g., 120), which may be received thereby at 610. The identity database may send artificial credentials therein to the website at 615 (e.g., if there may be one or more artificial credentials associated with the website associated with the pointer received at 610). For example, if the identity database may determine that there may be one or more artificial identities associated with the website the user may want to log into the one or more artificial credentials may be provided to the website at 615.

At 620, the identity database may provide an indication to the user agent that the website may not be in the database (e.g., that an artificial identity associated with the user for the website may not have been generated yet). For example, the identity database that that there may not be an artificial identity of a user for the website and may provide such an indication to the user agent at 620. In such an example, there may not be an artificial identity for the user if the user may not have logged into the website before and/or an artificial identity for the website may not have been created. The user agent may generate one or more artificial identities (e.g., new identities) for the website as described herein and may provide (e.g., send) them to the identity database for receipt thereby at 625. The one or more artificial credentials (e.g., the new identities) may then be sent and received by the website for logging thereon as described herein at 630.

The examples herein (e.g., the methods) may be used as a product provided by a range of companies including providers of web browsers themselves or providers of personal privacy protection. Further, the examples may be different from and may complement the standard method of anonymization through web proxy, such as hide.me and other services. For example, one or more of the differences may be as follows. A web proxy may hide a machine's IP address. The examples herein may obfuscate a user's digital identity when logging in a particular service (e.g., not only the machine's IP address). Additionally, a web proxy may deploy multiple physical machines in its implementation whereas the examples herein may create multiple digital identities in its implementation. It may be possible though to have a system and/or method that may use both the examples herein and the web proxy examples to hide user identity as well as a machine IP address.

Further, according to examples herein, the examples herein (e.g., compared to and different form current examples) may be automated. The examples herein may include a method and system that uses machine automation in the generation and management of identities. Human users may not need to be concerned with the chores of managing the identities. Machine automation may further ensure “random selection” and “load balancing” across the multiple identities.

The examples herein may also provide an ability to “glue” the various entities back together to form large dataset for monetization with user knowledge. This may be enabled one or more of the following aspects of the examples herein: storing metadata (e.g., of how the multiple identities are used) on client devices and/or an interface (e.g., the identity management or manager component) with big data monetization vendors, with signaling between vendors and users so that users can give permission in various formats to allow the “glue-back.”

The examples herein may further be extended to mobile applications. For example, the interface of the examples herein may apply to not just laptop/desktop web browser interface of Internet connections, but also to mobile client devices and mobile application interfaces.

This systems and/or methods herein of breaking up personal big data into smaller chunks of data, and the data being controlled by individual users, may have one or more impacts on a vendor ecosystem. For example, because of the monetization opportunities for the users and their digital identity management systems, there may likely be startup companies specialized in offering the service described herein. This may create a new kind of vendors to interact with the large companies such as vendors of education, e-commerce and entertainment content providers. Further, if these startups succeed in their business operation at scale, the large vendors described herein may 1 have to reposition their strategies to form partnerships with these successful startups and get first-rights to have a preferential access to the data now protected on client side. This may further differentiate some large vendors from the rest.

FIG. 7 depicts an example system diagram of a device 700 such as a mobile device, a tablet, a server, a system, a database, and/or the like to implement the examples as described herein. The components of the device 700 may include a processor 718, a transceiver 720, a transmit/receive element 722, a speaker/microphone 724, a keypad 726, a display/touchpad component or interface 728, non-removable memory 730, removable memory 732, a power source 734, a global positioning system (GPS) chipset 736, and other peripherals 738. It may be appreciated that the device may include any sub-combination of the foregoing elements while remaining consistent with this disclosure. Other devices and/or servers or systems described herein, may include some or all of the elements depicted in FIG. 7 and described herein.

The processor 718 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 718 may perform signal coding, data processing, power control, input/output processing, and/or any other functionality that may enable the device to operate in a wireless environment. The processor 718 may be coupled to the transceiver 720, which may be coupled to the transmit/receive element 722. While depicted as separate components, it may be appreciated that the processor 718 and the transceiver 720 may be integrated together in an electronic package or chip.

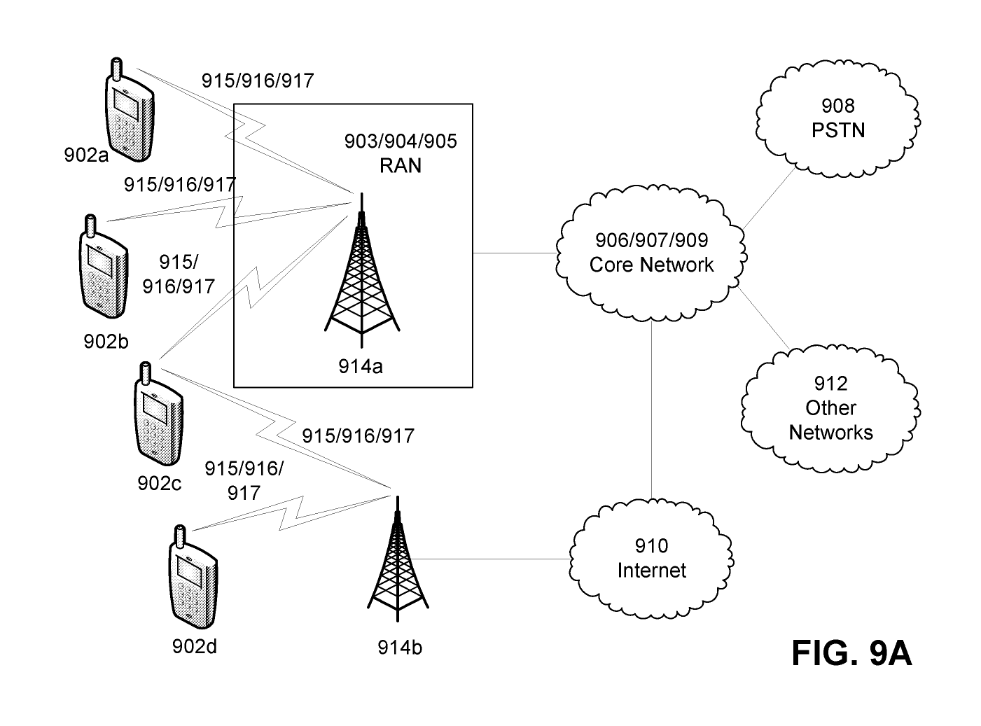

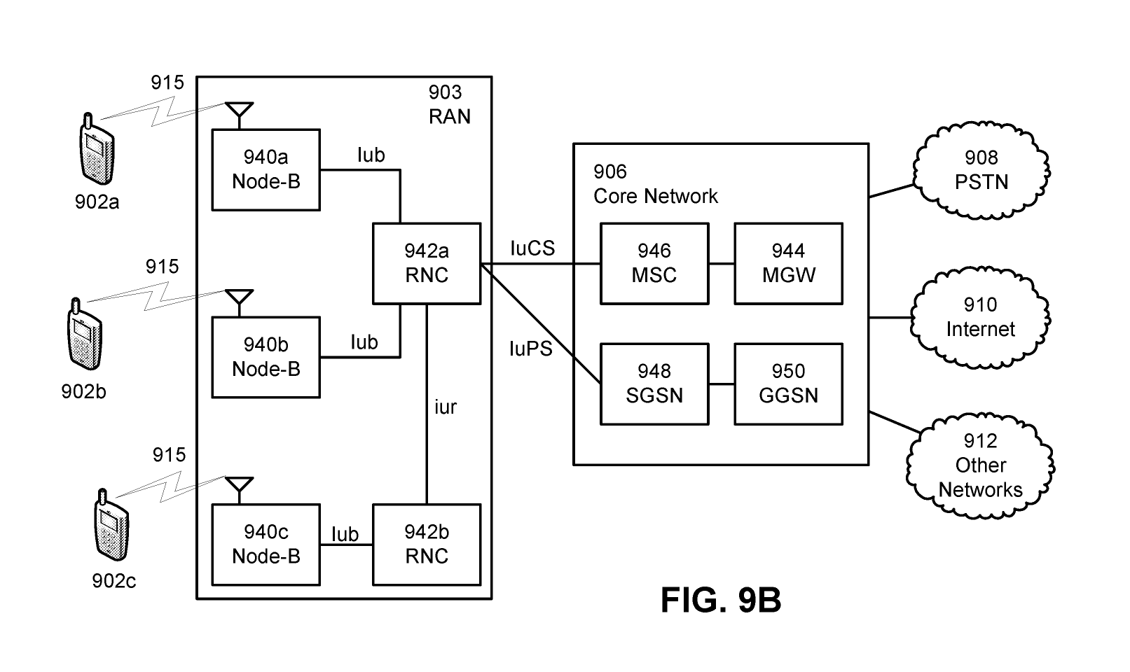

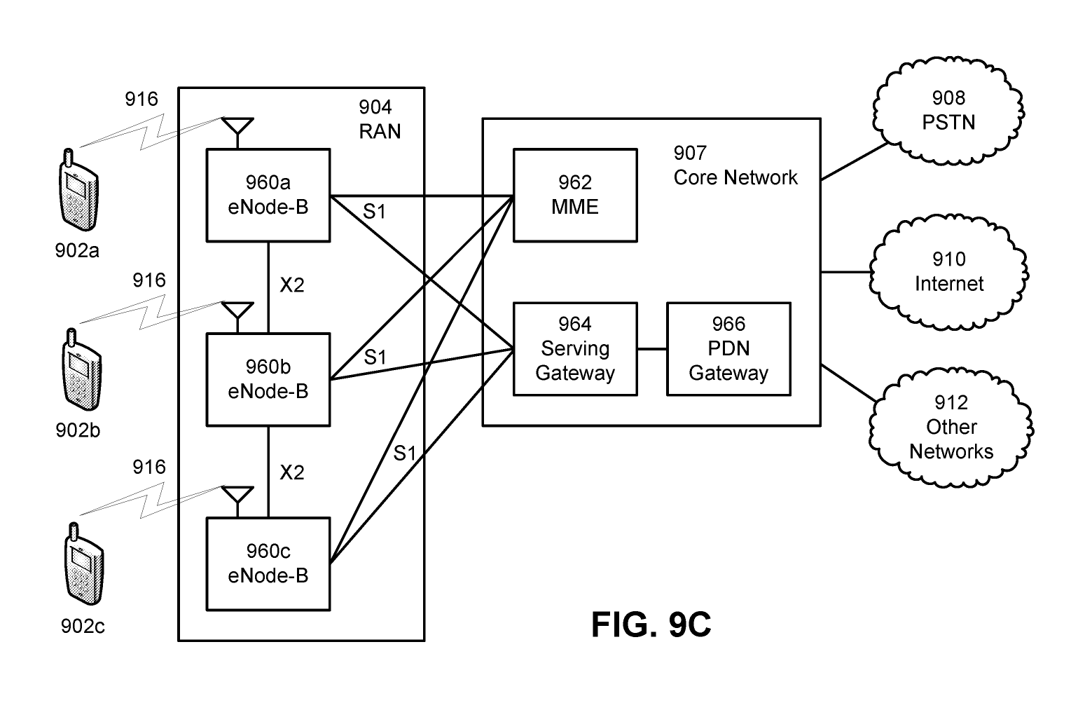

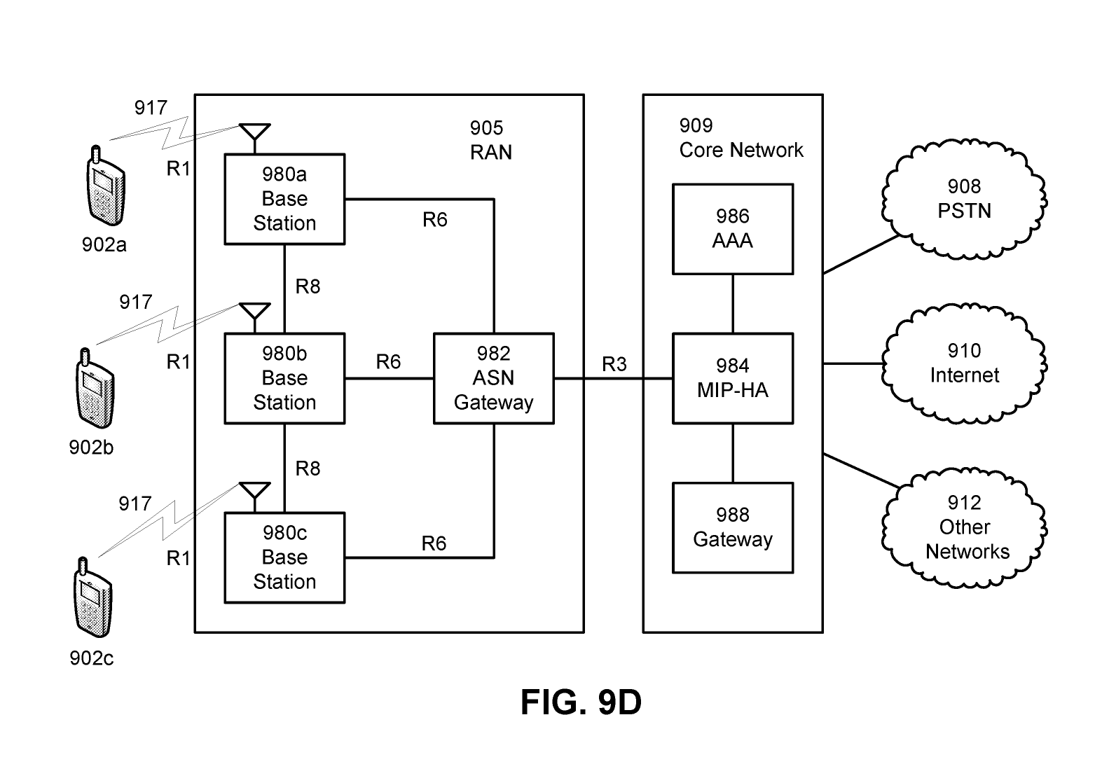

The transmit/receive element 722 may be configured to transmit signals to, or receive signals from, another device (e.g., the user's device and/or a network component such as a base station, access point, or other component in a wireless network) over an air interface 715/716/717 (e.g., 915/916/917 in FIGS. 9A-9D). For example, in one embodiment, the transmit/receive element 722 may be an antenna configured to transmit and/or receive RF signals. In another or additional embodiment, the transmit/receive element 722 may be an emitter/detector configured to transmit and/or receive IR, UV, or visible light signals, for example. In yet another or additional embodiment, the transmit/receive element 722 may be configured to transmit and receive both RF and light signals. It may be appreciated that the transmit/receive element 722 may be configured to transmit and/or receive any combination of wireless signals (e.g., Bluetooth, WiFi, and/or the like).

In addition, although the transmit/receive element 722 is depicted as a single element, the device may include any number of transmit/receive elements 722. More specifically, the device may employ MIMO technology. Thus, in one embodiment, the device may include two or more transmit/receive elements 722 (e.g., multiple antennas) for transmitting and receiving wireless signals over the air interface 715/716/717.

The transceiver 720 may be configured to modulate the signals that are to be transmitted by the transmit/receive element 722 and to demodulate the signals that are received by the transmit/receive element 722. As noted above, the device may have multi-mode capabilities. Thus, the transceiver 720 may include multiple transceivers for enabling the device to communicate via multiple RATs, such as UTRA and IEEE 802.11, for example.

The processor 718 of the device may be coupled to, and may receive user input data from, the speaker/microphone 724, the keypad or touch interface 726, and/or the display/touchpad 728 (e.g., a liquid crystal display (LCD) display unit or organic light-emitting diode (OLED) display unit). The processor 718 may also output user data to the speaker/microphone 724, the keypad 726, and/or the display/touchpad 728. In addition, the processor 718 may access information from, and store data in, any type of suitable memory, such as the non-removable memory 730 and/or the removable memory 732. The non-removable memory 730 may include random-access memory (RAM), read-only memory (ROM), a hard disk, or any other type of memory storage device. The removable memory 732 may include a subscriber identity module (SIM) card, a memory stick, a secure digital (SD) memory card, and the like. In other embodiments, the processor 718 may access information from, and store data in, memory that is not physically located on the device, such as on a server or a home computer (not shown). The removable memory 730 and/or non-removable memory 732 may store a user profile or other information associated therewith that may be used as described herein.

The processor 718 may receive power from the power source 734, and may be configured to distribute and/or control the power to the other components in the device. The power source 734 may be any suitable device for powering the device. For example, the power source 734 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 718 may also be coupled to the GPS chipset 736, which may be configured to provide location information (e.g., longitude and latitude) regarding the current location of the device. In addition to, or in lieu of, the information from the GPS chipset 736, the device may receive location information over the air interface 715/716/717 from another device or network component and/or determine its location based on the timing of the signals being received from two or more nearby network components. It may be appreciated that the device may acquire location information by way of any suitable location-determination method while remaining consistent with an embodiment.

The processor 718 may further be coupled to other peripherals 738, which may include one or more software and/or hardware modules that provide additional features, functionality and/or wired or wireless connectivity. For example, the peripherals 738 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 8 depicts a block diagram of a computing system or device 800 such as a mobile device, a tablet, a server, a system, a database, and/or the like to implement the examples as described herein. The components of the device may be capable of executing a variety of computing applications, including application 805. Application 805 may include a computing application, a computing applet, a computing program and other instruction set operative on the computing system 800 to perform at least one function, operation, and/or procedure as described herein. Application 805 may be stored in a storage component 807 (and/or RAM or ROM described herein).

The device 800 may be controlled primarily by computer readable instructions that may be in the form of software. The computer readable instructions may include instructions for the device for storing and accessing the computer readable instructions themselves. Such software may be executed within a processor 810 such as a central processing unit (CPU) and/or other processors such as a co-processor to cause the device to perform the processes or functions associated therewith. The processor 810 may be implemented by micro-electronic chips CPUs called microprocessors.

In operation, the processor 810 may fetch, decode, and/or execute instructions and may transfer information to and from other resources via an interface 815 such as a main data-transfer path or a system bus. Such an interface or system bus may connect the components in the device and may define the medium for data exchange. The device may further include memory devices controlled by a memory controller 820 coupled to the interface 815. The memory devices may include a random access memory (RAM) 825 and read only memory (ROM) 830. The RAM 825 and ROM 830 may include circuitry that allows information to be stored and retrieved. The ROM 830 may include stored data that cannot be modified. Additionally, data stored in the RAM 825 typically may be read or changed by the processor 810 or other hardware devices. Access to the RAM 825 and/or ROM 830 may be controlled by the memory controller 820. The memory controller 820 may provide an address translation function that translates virtual addresses into physical addresses as instructions are executed.

In addition, the may include a peripherals controller 835 that may be responsible for communicating instructions from the processor 810 to peripherals such as a printer, a keypad or keyboard, a mouse, and a storage component. The device may further include a display controller 840. The display/display controller 840 may be used to display visual output generated by the device. Such visual output may include text, graphics, animated graphics, video, or the like. The display controller associated with the display (e.g., shown in combination, but may be separate components) may include electronic components that generate a video signal that may be sent to the display. Further, the device may include a network interface or controller 845 (e.g., a network adapter) that may be used to connect the device to an external communication network and/or other devices (not shown).

FIG. 9A depicts a diagram of an example communications system in which one or more disclosed embodiments such as the example devices, the authentication server, the group server and/or the like may be implemented and/or may be used (e.g., to connect the device to the authentication server using the WLAN or cellular data interface). The communications system may be a multiple access system that provides content, such as voice, data, video, messaging, broadcast, etc., to multiple wireless users. The communications system may enable multiple wireless users to access such content through the sharing of system resources, including wireless bandwidth. For example, the communications systems may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 9A, the communications system may include wireless transmit/receive units (WTRUs) 902a, 902b, 902c, and/or 902d (which generally or collectively may be referred to as WTRU 902), a radio access network (RAN) 903/904/905, a core network 906/907/909, a public switched telephone network (PSTN) 908, the Internet 910, and other networks 912, though it will be appreciated that the disclosed embodiments contemplate any number of WTRUs, base stations, networks, and/or network elements. Each of the WTRUs 902a, 902b, 902c, and/or 902d may be any type of device configured to operate and/or communicate in a wireless environment. By way of example, the WTRUs 902a, 902b, 902c, and/or 902d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems may also include a base station 914a and a base station 914b. Each of the base stations 914a, 914b may be any type of device configured to wirelessly interface with at least one of the WTRUs 902a, 902b, 902c, and/or 902d to facilitate access to one or more communication networks, such as the core network 906/907/909, the Internet 910, and/or the networks 912. By way of example, the base stations 914a and/or 914b may be a base transceiver station (BTS), a Node-B, an eNode B, a Home Node B, a Home eNode B, a site controller, an access point (AP), a wireless router, and the like. While the base stations 914a, 914b are each depicted as a single element, it will be appreciated that the base stations 914a, 914b may include any number of interconnected base stations and/or network elements.

The base station 914a may be part of the RAN 903/904/905, which may also include other base stations and/or network elements (not shown), such as a base station controller (BSC), a radio network controller (RNC), relay nodes, etc. The base station 914a and/or the base station 914b may be configured to transmit and/or receive wireless signals within a particular geographic region, which may be referred to as a cell (not shown). The cell may further be divided into cell sectors. For example, the cell associated with the base station 914a may be divided into three sectors. Thus, in one embodiment, the base station 914a may include three transceivers, i.e., one for each sector of the cell. In another embodiment, the base station 914a may employ multiple-input multiple output (MIMO) technology and, therefore, may utilize multiple transceivers for each sector of the cell.

The base stations 914a and/or 914b may communicate with one or more of the WTRUs 902a, 902b, 902c, and/or 902d over an air interface 915/916/917, which may be any suitable wireless communication link (e.g., radio frequency (RF), microwave, infrared (IR), ultraviolet (UV), visible light, etc.). The air interface 915/916/917 may be established using any suitable radio access technology (RAT).

More specifically, as noted above, the communications system may be a multiple access system and may employ one or more channel access schemes, such as CDMA, TDMA, FDMA, OFDMA, SC-FDMA, and the like. For example, the base station 914a in the RAN 903/904/905 and the WTRUs 902a, 902b, and/or 902c may implement a radio technology such as Universal Mobile Telecommunications System (UMTS) Terrestrial Radio Access (UTRA), which may establish the air interface 915/916/917 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 914a and the WTRUs 902a, 902b, and/or 902c may implement a radio technology such as Evolved UMTS Terrestrial Radio Access (E-UTRA), which may establish the air interface 915/916/917 using Long Term Evolution (LTE) and/or LTE-Advanced (LTE-A).

In other embodiments, the base station 914a and the WTRUs 902a, 902b, and/or 902c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 914b in FIG. 9A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 914b and the WTRUs 902c, 902d may implement a radio technology such as IEEE 802.11 to establish a wireless local area network (WLAN). In another embodiment, the base station 914b and the WTRUs 902c, 902d may implement a radio technology such as IEEE 802.15 to establish a wireless personal area network (WPAN). In yet another embodiment, the base station 914b and the WTRUs 902c, 902d may utilize a cellular-based RAT (e.g., WCDMA, CDMA2000, GSM, LTE, LTE-A, etc.) to establish a picocell or femtocell. As shown in FIG. 9A, the base station 914b may have a direct connection to the Internet 910. Thus, the base station 914b may not be required to access the Internet 910 via the core network 906/907/909.

The RAN 903/904/905 may be in communication with the core network 906/907/909, which may be any type of network configured to provide voice, data, applications, and/or voice over internet protocol (VoIP) services to one or more of the WTRUs 902a, 902b, 902c, and/or 902d. For example, the core network 906/907/909 may provide call control, billing services, mobile location-based services, pre-paid calling, Internet connectivity, video distribution, etc., and/or perform high-level security functions, such as user authentication. Although not shown in FIG. 9A, it will be appreciated that the RAN 903/904/905 and/or the core network 906/907/909 may be in direct or indirect communication with other RANs that employ the same RAT as the RAN 903/904/905 or a different RAT. For example, in addition to being connected to the RAN 903/904/905, which may be utilizing an E-UTRA radio technology, the core network 906/907/909 may also be in communication with another RAN (not shown) employing a GSM radio technology.

The core network 906/907/909 may also serve as a gateway for the WTRUs 902a, 902b, 902c, and/or 902d to access the PSTN 908, the Internet 910, and/or other networks 912. The PSTN 908 may include circuit-switched telephone networks that provide plain old telephone service (POTS). The Internet 910 may include a global system of interconnected computer networks and devices that use common communication protocols, such as the transmission control protocol (TCP), user datagram protocol (UDP) and the internet protocol (IP) in the TCP/IP interne protocol suite. The networks 912 may include wired or wireless communications networks owned and/or operated by other service providers. For example, the networks 912 may include another core network connected to one or more RANs, which may employ the same RAT as the RAN 903/904/905 or a different RAT.

Some or all of the WTRUs 902a, 902b, 902c, and/or 902d in the communications system may include multi-mode capabilities, i.e., the WTRUs 902a, 902b, 902c, and/or 902d may include multiple transceivers for communicating with different wireless networks over different wireless links. For example, the WTRU 902c shown in FIG. 9A may be configured to communicate with the base station 914a, which may employ a cellular-based radio technology, and with the base station 914b, which may employ an IEEE 802 radio technology.

FIG. 9B depicts a system diagram of the RAN 903 and the core network 906 according to an embodiment. As noted above, the RAN 903 may employ a UTRA radio technology to communicate with the WTRUs 902a, 902b, and/or 902c over the air interface 915. The RAN 903 may also be in communication with the core network 906. As shown in FIG. 9B, the RAN 903 may include Node-Bs 940a, 940b, and/or 940c, which may each include one or more transceivers for communicating with the WTRUs 902a, 902b, and/or 902c over the air interface 915. The Node-Bs 940a, 940b, and/or 940c may each be associated with a particular cell (not shown) within the RAN 903. The RAN 903 may also include RNCs 942a and/or 942b. It will be appreciated that the RAN 903 may include any number of Node-Bs and RNCs while remaining consistent with an embodiment.

As shown in FIG. 9B, the Node-Bs 940a and/or 940b may be in communication with the RNC 942a. Additionally, the Node-B 940c may be in communication with the RNC 942b. The Node-Bs 940a, 940b, and/or 940c may communicate with the respective RNCs 942a, 942b via an Iub interface. The RNCs 942a, 942b may be in communication with one another via an Iur interface. Each of the RNCs 942a, 942b may be configured to control the respective Node-Bs 940a, 940b, and/or 940c to which it is connected. In addition, each of the RNCs 942a, 942b may be configured to carry out or support other functionality, such as outer loop power control, load control, admission control, packet scheduling, handover control, macrodiversity, security functions, data encryption, and the like.

The core network 906 shown in FIG. 9B may include a media gateway (MGW) 944, a mobile switching center (MSC) 946, a serving GPRS support node (SGSN) 948, and/or a gateway GPRS support node (GGSN) 950. While each of the foregoing elements are depicted as part of the core network 906, it will be appreciated that any one of these elements may be owned and/or operated by an entity other than the core network operator.

The RNC 942a in the RAN 903 may be connected to the MSC 946 in the core network 906 via an IuCS interface. The MSC 946 may be connected to the MGW 944. The MSC 946 and the MGW 944 may provide the WTRUs 902a, 902b, and/or 902c with access to circuit-switched networks, such as the PSTN 908, to facilitate communications between the WTRUs 902a, 902b, and/or 902c and traditional land-line communications devices.

The RNC 942a in the RAN 903 may also be connected to the SGSN 948 in the core network 906 via an IuPS interface. The SGSN 948 may be connected to the GGSN 950. The SGSN 948 and the GGSN 950 may provide the WTRUs 902a, 902b, and/or 902c with access to packet-switched networks, such as the Internet 910, to facilitate communications between and the WTRUs 902a, 902b, and/or 902c and IP-enabled devices.

As noted above, the core network 906 may also be connected to the networks 912, which may include other wired or wireless networks that are owned and/or operated by other service providers.

FIG. 9C depicts a system diagram of the RAN 904 and the core network 907 according to an embodiment. As noted above, the RAN 904 may employ an E-UTRA radio technology to communicate with the WTRUs 902a, 902b, and/or 902c over the air interface 916. The RAN 904 may also be in communication with the core network 907.

The RAN 904 may include eNode-Bs 960a, 960b, and/or 960c, though it will be appreciated that the RAN 904 may include any number of eNode-Bs while remaining consistent with an embodiment. The eNode-Bs 960a, 960b, and/or 960c may each include one or more transceivers for communicating with the WTRUs 902a, 902b, and/or 902c over the air interface 916. In one embodiment, the eNode-Bs 960a, 960b, and/or 960c may implement MIMO technology. Thus, the eNode-B 960a, for example, may use multiple antennas to transmit wireless signals to, and receive wireless signals from, the WTRU 902a.

Each of the eNode-Bs 960a, 960b, and/or 960c may be associated with a particular cell (not shown) and may be configured to handle radio resource management decisions, handover decisions, scheduling of users in the uplink and/or downlink, and the like. As shown in FIG. 9C, the eNode-Bs 960a, 960b, and/or 960c may communicate with one another over an X2 interface.

The core network 907 shown in FIG. 9C may include a mobility management gateway (MME) 962, a serving gateway 964, and a packet data network (PDN) gateway 966. While each of the foregoing elements are depicted as part of the core network 907, it will be appreciated that any one of these elements may be owned and/or operated by an entity other than the core network operator.

The MME 962 may be connected to each of the eNode-Bs 960a, 960b, and/or 960c in the RAN 904 via an S1 interface and may serve as a control node. For example, the MME 962 may be responsible for authenticating users of the WTRUs 902a, 902b, and/or 902c, bearer activation/deactivation, selecting a particular serving gateway during an initial attach of the WTRUs 902a, 902b, and/or 902c, and the like. The MME 962 may also provide a control plane function for switching between the RAN 904 and other RANs (not shown) that employ other radio technologies, such as GSM or WCDMA.

The serving gateway 964 may be connected to each of the eNode-Bs 960a, 960b, and/or 960c in the RAN 904 via the S1 interface. The serving gateway 964 may generally route and forward user data packets to/from the WTRUs 902a, 902b, and/or 902c. The serving gateway 964 may also perform other functions, such as anchoring user planes during inter-eNode B handovers, triggering paging when downlink data is available for the WTRUs 902a, 902b, and/or 902c, managing and storing contexts of the WTRUs 902a, 902b, and/or 902c, and the like.

The serving gateway 964 may also be connected to the PDN gateway 966, which may provide the WTRUs 902a, 902b, and/or 902c with access to packet-switched networks, such as the Internet 910, to facilitate communications between the WTRUs 902a, 902b, and/or 902c and IP-enabled devices.

The core network 907 may facilitate communications with other networks. For example, the core network 907 may provide the WTRUs 902a, 902b, and/or 902c with access to circuit-switched networks, such as the PSTN 908, to facilitate communications between the WTRUs 902a, 902b, and/or 902c and traditional land-line communications devices. For example, the core network 907 may include, or may communicate with, an IP gateway (e.g., an IP multimedia subsystem (IMS) server) that serves as an interface between the core network 907 and the PSTN 908. In addition, the core network 907 may provide the WTRUs 902a, 902b, and/or 902c with access to the networks 912, which may include other wired or wireless networks that are owned and/or operated by other service providers.

FIG. 9D depicts a system diagram of the RAN 905 and the core network 909 according to an embodiment. The RAN 905 may be an access service network (ASN) that employs IEEE 802.16 radio technology to communicate with the WTRUs 902a, 902b, and/or 902c over the air interface 917. As will be further discussed below, the communication links between the different functional entities of the WTRUs 902a, 902b, and/or 902c, the RAN 905, and the core network 909 may be defined as reference points.

As shown in FIG. 9D, the RAN 905 may include base stations 980a, 980b, and/or 980c, and an ASN gateway 982, though it will be appreciated that the RAN 905 may include any number of base stations and ASN gateways while remaining consistent with an embodiment. The base stations 980a, 980b, and/or 980c may each be associated with a particular cell (not shown) in the RAN 905 and may each include one or more transceivers for communicating with the WTRUs 902a, 902b, and/or 902c over the air interface 917. In one embodiment, the base stations 980a, 980b, and/or 980c may implement MIMO technology. Thus, the base station 980a, for example, may use multiple antennas to transmit wireless signals to, and receive wireless signals from, the WTRU 902a. The base stations 980a, 980b, and/or 980c may also provide mobility management functions, such as handoff triggering, tunnel establishment, radio resource management, traffic classification, quality of service (QoS) policy enforcement, and the like. The ASN gateway 982 may serve as a traffic aggregation point and may be responsible for paging, caching of subscriber profiles, routing to the core network 909, and the like.

The air interface 917 between the WTRUs 902a, 902b, and/or 902c and the RAN 905 may be defined as an R1 reference point that implements the IEEE 802.16 specification. In addition, each of the WTRUs 902a, 902b, and/or 902c may establish a logical interface (not shown) with the core network 909. The logical interface between the WTRUs 902a, 902b, and/or 902c and the core network 909 may be defined as an R2 reference point, which may be used for authentication, authorization, IP host configuration management, and/or mobility management.

The communication link between each of the base stations 980a, 980b, and/or 980c may be defined as an R8 reference point that includes protocols for facilitating WTRU handovers and the transfer of data between base stations. The communication link between the base stations 980a, 980b, and/or 980c and the ASN gateway 982 may be defined as an R6 reference point. The R6 reference point may include protocols for facilitating mobility management based on mobility events associated with each of the WTRUs 902a, 902b, and/or 902c.

As shown in FIG. 9D, the RAN 905 may be connected to the core network 909. The communication link between the RAN 905 and the core network 909 may defined as an R3 reference point that includes protocols for facilitating data transfer and mobility management capabilities, for example. The core network 909 may include a mobile IP home agent (MIP-HA) 984, an authentication, authorization, accounting (AAA) server 986, and a gateway 988. While each of the foregoing elements are depicted as part of the core network 909, it will be appreciated that any one of these elements may be owned and/or operated by an entity other than the core network operator.

The MIP-HA may be responsible for IP address management, and may enable the WTRUs 902a, 902b, and/or 902c to roam between different ASNs and/or different core networks. The MIP-HA 984 may provide the WTRUs 902a, 902b, and/or 902c with access to packet-switched networks, such as the Internet 910, to facilitate communications between the WTRUs 902a, 902b, and/or 902c and IP-enabled devices. The AAA server 986 may be responsible for user authentication and for supporting user services. The gateway 988 may facilitate interworking with other networks. For example, the gateway 988 may provide the WTRUs 902a, 902b, and/or 902c with access to circuit-switched networks, such as the PSTN 908, to facilitate communications between the WTRUs 902a, 902b, and/or 902c and traditional land-line communications devices. In addition, the gateway 988 may provide the WTRUs 902a, 902b, and/or 902c with access to the networks 912, which may include other wired or wireless networks that are owned and/or operated by other service providers.

Although not shown in FIG. 9D, it should, may, and/or will be appreciated that the RAN 905 may be connected to other ASNs and the core network 909 may be connected to other core networks. The communication link between the RAN 905 the other ASNs may be defined as an R4 reference point, which may include protocols for coordinating the mobility of the WTRUs 902a, 902b, and/or 902c between the RAN 905 and the other ASNs. The communication link between the core network 909 and the other core networks may be defined as an R5 reference, which may include protocols for facilitating interworking between home core networks and visited core networks.

Although the terms device, server, and/or the like may be used herein, it may and should be understood that the use of such terms may be used interchangeably and, as such, may not be distinguishable.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method to process personal information implemented in an entity on a wireless transmit/receive unit (WTRU), the method comprising:
receiving, from a user, an indication associated with a first browsing session, wherein the first browsing session is associated with a website;
selecting, by the entity, a first artificial digital identity associated with the first browsing session;
storing first browsing information associated with the first browsing session, wherein the first browsing information is associated with the user;
receiving, from the user, an indication associated with a second browsing session, wherein the second browsing session is associated with the website;
selecting, by the entity, a second artificial digital identity associated with the second browsing session;
storing second browsing information associated with the second browsing session, wherein the second browsing information is associated with the user;
wherein, upon initiating a further browsing session at the website, the entity randomly selects the first artificial digital identity or the second artificial digital identity and provides the selected artificial digital identity to the website;
receiving a request for a browsing history and sending the request to the user, wherein the request is associated with the website;
on a condition that the user accepts the request, sending the browsing history in response to the request, wherein the browsing history combines the first browsing information and the second browsing information.

2. The method of claim 1, further comprising:
in response to receiving the indication associated with the first browsing session, the entity establishing a connection with the website and logging in the user or coordinating browsing using the first artificial digital identity.

3. The method of claim 2, further comprising:
in response to receiving the indication associated with the second browsing session, the entity establishing a connection with the website and logging in the user or coordinating browsing using the second artificial digital identity.

4. The method of claim 3, wherein the entity does not provide the first browsing information to the website during the second browsing session.

5. The method of claim 1, wherein the first browsing information comprises first cookies and the second browsing information comprises second cookies.

6.-7. (canceled)

8. The method of claim 1, further comprising creating a plurality of artificial identities.

9. The method of claim 8, wherein the first artificial digital identity and the second artificial digital identity are selected randomly or systematically from the plurality of created artificial identities.

10. The method of claim 1, wherein the first artificial digital identity is created contemporaneously with the first browsing session and the second artificial digital identity is created contemporaneously with the second browsing session.

11. A wireless transmit/receive unit (WTRU) comprising:
a memory; and
a processor, wherein the WTRU is configured at least in part to:
receive, from a user, an indication associated with a first browsing session, wherein the first browsing session is associated with a website;
select a first artificial digital identity associated with the first browsing session;
store first browsing information associated with the first browsing session, wherein the first browsing information is associated with the user;
receive, from the user, an indication associated with a second browsing session, wherein the second browsing session is associated with the website;
select a second artificial digital identity associated with the second browsing session;
store second browsing information associated with the second browsing session, wherein the second browsing information is associated with the user;
initiate a further browsing session at the website, wherein the entity randomly selects the first artificial digital identity or the second artificial digital identity and provides the selected artificial digital identity to the website;
receive a request for a browsing history and send the request to the user, wherein the request is associated with the website;
on a condition that the user accepts the request, send the browsing history in response to the request, wherein the browsing history combines the first browsing information and the second browsing information.

12. The WTRU of claim 11, further comprising:
in response to receiving the indication associated with the first browsing session, the WTRU establishing a connection with the website and logging in the user or coordinating browsing using the first artificial digital identity.

13. The WTRU of claim 12, further comprising:
in response to receiving the indication associated with the second browsing session, the WTRU establishing a connection with the website and logging in the user or coordinating browsing using the second artificial digital identity, wherein the WTRU does not provide the first browsing information to the website during the second browsing session.

14. (canceled)

15. The WTRU of claim 11, wherein the first browsing information comprises first cookies and the second browsing information comprises second cookies.

16.-17. (canceled)

18. The WTRU of claim 11, wherein the WTRU is further configured to create a plurality of artificial identities.

19. The WTRU of claim 18, wherein the first artificial digital identity and the second artificial digital identity are selected randomly or systematically from the plurality of created artificial identities.

20. The WTRU of claim 11, wherein the first artificial digital identity is created contemporaneously with the first browsing session and the second artificial digital identity is created contemporaneously with the second browsing session.

21. The method of claim 1, further comprising:
in response to initiating the further browsing session, the entity establishing a connection with the website and logging in the user or coordinating browsing using the selected artificial digital identity.

22. The method of claim 1, further comprising mapping the first artificial digital identity and the second artificial digital identity to a true identity of the user.

23. The method of claim 22, further comprising, on a condition that the user accepts the request, sending the mapping in response to the request.

24. The WTRU of claim 11, further comprising:
in response to initiating the further browsing session, the WTRU establishing a connection with the website and logging in the user or coordinating browsing using the selected artificial digital identity.

25. The WTRU of claim 11, wherein the WTRU is further configured to create a mapping of the first artificial digital identity and the second artificial digital identity to a true identity of the user, and wherein the WTRU is further configured to, on a condition that the user accepts the request, send the mapping in response to the request.

26. (canceled)
